(19) United States
(12) Patent Application Publication
(10) Pub. No.: US 2003/0154087 A1
(43) Pub. Date: Aug. 14, 2003

(54) Method of enhancing air travel security

(76) Inventor: Tobias Lewenstein, Tucson, AZ (US)

Correspondence Address: Tobias Lewenstein, 1516 W. Sunset Ridge Place, Tucson, AR, 85737, US

(21) Appl. No.: 10/072,689

(22) Filed: Feb. 8, 2002

(51) Int. Cl. G06F 17/60

(52) U.S. Cl. 705/1

(57) ABSTRACT

Travelers are boarded onto a commercial passenger aircraft at a departure airport and the aircraft then files to an arrival airport with no checked-in luggage on board. Luggage which belongs to the travelers and cannot be carried onto the aircraft is transported by cargo carrier to a location where the luggage can be retrieved by the travelers after they have landed at the arrival airport.

### BACKGROUND OF THE INVENTION

1. Field of the Invention

The invention relates to air travel security.

2. Description of the Prior Art

Security when traveling by air has lately taken on added importance. An area of particular concern at this time is checked luggage, that is, luggage which is checked in at an airline ticket counter and does not pass through a security checkpoint together with a traveler.

Until now, only a small fraction of the luggage checked in at an airline ticket counter has been inspected to detect the presence of dangerous substances and items. In view of the recently increased risk of terrorism, the government is requiring the airlines to carry out at least one of the following four procedures for checked luggage: (1) inspect the luggage by machine; (2) inspect the luggage by hand; (3) inspect the luggage by having dogs sniff the luggage; and (4) match each item of checked luggage loaded onto an aircraft to a passenger in the aircraft. Each of these procedures is burdensome.

### SUMMARY OF THE INVENTION

It is an object of the invention to enhance the security of an aircraft relatively simply.

The preceding object, as well as others which will become apparent as the description proceeds, are achieved by the invention.

One aspect of the invention resides in a method of rendering air-travel service. The method comprises the step of conveying travelers by air to a predetermined destination. The travelers have articles of non-carry-on luggage, and the conveying step is performed with an aircraft devoid of non-carry-on luggage belonging to any traveler on the aircraft. The method further comprises the step of transporting the articles of non-carry-on luggage to one or more locations where such articles are retrievable by the travelers following arrival of the travelers at the predetermined destination. The transporting step is performed with one or more conveyances other than the aircraft used to convey the travelers.

In accordance with the invention, any luggage belonging to a traveler on an aircraft is carry-on luggage thereby making it possible to eliminate the inspection requirements imposed by the government for luggage which is checked in at an airline ticket counter. This allows the security of an aircraft to be improved in a relatively simple fashion.

An article of non-carry-on luggage belonging to one of the travelers can be transported to a predetermined location selected by the traveler. By way of example, the location to which this article of non-carry-on luggage is transported may be at an airfield, at a lodging facility or at a residence.

The aircraft used to convey the travelers can be operated by a first party while at least one of the conveyances used to transport the articles of non-carry-on luggage may be operated by a second party.

The method can further comprise the steps of collecting one of the articles of non-carry-on luggage from a preselected location prior to the transporting step, and loading the article on a selected conveyance for transport. If the article is collected at a location other than an airfield, e.g., a residence or lodging facility, the collecting step and the loading step preferably are each performed by the second party. On the other hand, if the article is collected from a traveler at an airfield, the loading step is advantageously carried out by the second party whereas the collecting step can be performed by the first party, the second part or some other party.

Preferred conveyances for transportation of the articles of non-carry-on luggage are cargo aircraft and trucks

Additional features and advantages of the invention will be forthcoming from the following detailed description of certain specific embodiments when read in conjunction with the accompanying drawings.

### BRIEF DESCRIPTION OF THE DRAWINGS

FIG. 1 is a partly broken away side view of one type of commercial aircraft in flight;

FIG. 2 is a perspective view of another type of commercial aircraft during boarding;

FIG. 3 is a perspective view of a cargo truck operated by a parcel delivery service; and

FIG. 4 is a perspective view of a cargo aircraft operated by the parcel delivery service.

### DESCRIPTION OF THE PREFERRED EMBODIMENTS

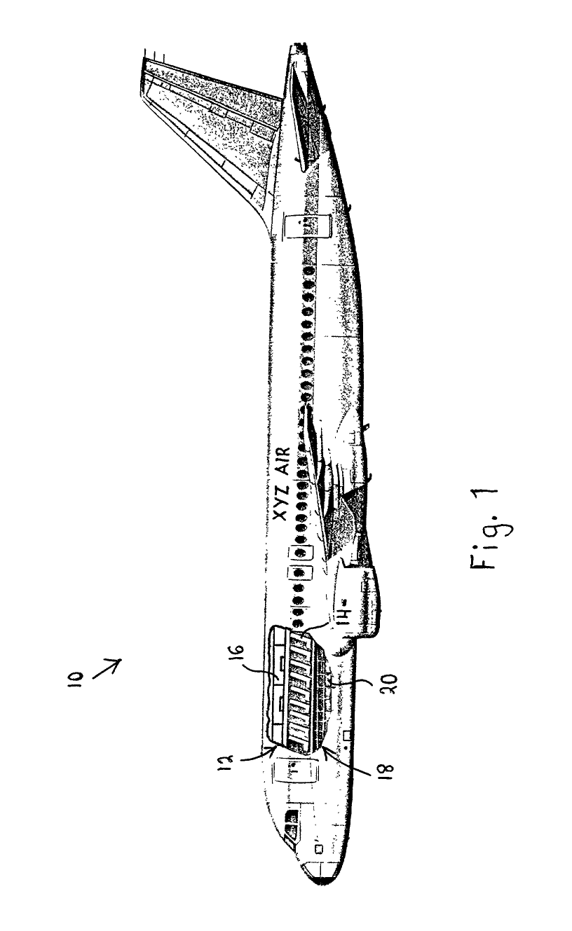

Referring to FIG. 1, the numeral 10 identifies a commercial passenger aircraft operated by an airline company XYZ Air. The aircraft 10 has a passenger compartment 12 which is provided with seats 14 for travelers or passengers using the aircraft 10 to fly from one airport or airfield to another airport or airfield. XYZ Air typically collects a fare from each traveler flying on the aircraft 10 although there may be exceptions, e.g., for employees of XYZ Air.

The passenger compartment 12 is also provided with overhead bins 16 for the storage of carry-on luggage brought onto the aircraft 10 by the travelers. Carry-on luggage, or a carry-on, herein refers to luggage which passes through a security checkpoint together with a traveler.

In addition to the passenger compartment 12, the aircraft 10 has a baggage compartment 18 which is located below the passenger compartment 12. The baggage compartment 18 is provided with bins 20 which are currently used to store checked-in luggage belonging to the travelers on the aircraft 10. Checked-in luggage herein refers to luggage which does not pass through a security checkpoint together with a traveler and is given to airline personnel for loading onto the aircraft 10.

A person wishing to travel from one airport to another on XYZ Air books an appropriate flight operated by this airline company. The booking may be accomplished in any conventional manner, e.g., by calling XYZ Air, by calling a travel agent or by going onto the internet. The traveler typically pays for the flight prior to departure.

On the day of departure, the traveler arrives at the departure or origin airport and checks in with XYZ Air. Check-in can be done at an XYZ ticket counter before passing through the security checkpoint at the departure airport. Alternatively, check-in can be accomplished after the traveler has passed through the security checkpoint. In this case, check-in takes place at the gate from which the traveler's flight is to depart. The traveler receives a boarding pass upon checking in.

According to the invention, no luggage is accepted for check-in at the XYZ ticket counter. Any luggage which the traveler has with him or her must pass through the security checkpoint together with the traveler and such luggage is herein referred to as carry-on luggage. Other luggage which the traveler may have packed for his or her trip is referred to as non-carry-on luggage.

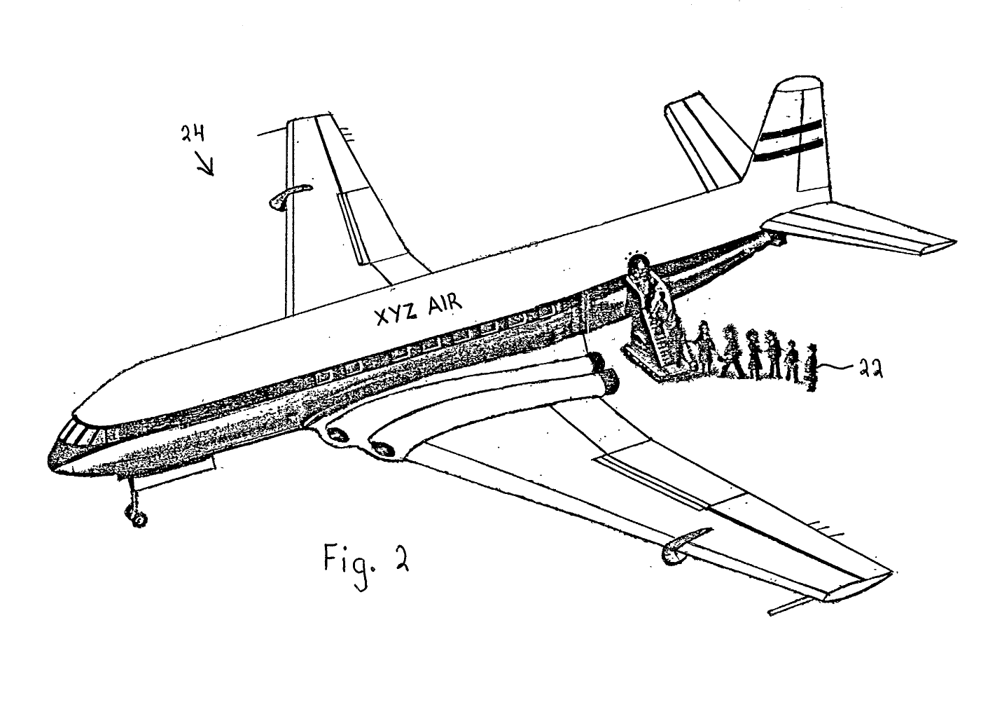

When departure time approaches, a gate agent of XYZ Air begins boarding the aircraft assigned to the traveler's flight. The boarding process proceeds in a customary manner and order with each traveler on the flight presenting their boarding pass to the gate agent prior to boarding the aircraft. FIG. 2 shows travelers 22, including some with carry-on luggage, boarding an aircraft 24 of XYZ Air.

Upon boarding the aircraft 24, each traveler who has taken aboard carry-on luggage stores the luggage in an overhead bin or underneath a seat. Each traveler takes a seat and fastens his or her seat belt preparatory to departure. The aircraft 24 is closed once preparations for departure have been completed and is then pushed back from the gate if necessary. The aircraft 24 subsequently taxis to the runway and, after having been cleared for takeoff, turns onto the runway and departs from the departure airport. The aircraft 24 flies from the departure airport to an arrival or destination airport where the aircraft 24 lands and taxis to a terminal. At the terminal, the travelers on the aircraft 24 are permitted to deplane.

In accordance with the invention, non-carry-on luggage belonging to the travelers on the aircraft 24 is not present on the aircraft 24 during the flight from the departure airport to the arrival airport.

Typically, one or more travelers on the aircraft 24 will have packed non-carry-on luggage for their trip. The non-carry-on luggage belonging to a traveler on the aircraft 24 is sent to a location where the traveler can retrieve the luggage after the traveler has arrived at the arrival airport.

For the purpose of the following description, the term “terminal location” is a location at which non-carry-on luggage is deposited for retrieval by a traveler once the traveler has arrived at the arrival airport. On the other hand, the term “starting location” is a location at which non-carry-on luggage is dropped off, or from which non-carry-on luggage is picked up, for transport to the terminal location.

Non-carry-on luggage belonging to a traveler is advantageously transported from the starting location to the terminal location by one or more cargo carriers. The cargo carriers are preferably cargo aircraft and cargo trucks but, depending upon the circumstances, could also be cargo ships and cargo railcars.

It is preferred to send non-carry-on luggage from the starting location to the terminal location via a delivery service, that is, an entity engaged in the business of delivering parcels, packages and other items to residences, places of business and other locations requested by a customer. Of particular advantage are delivery services which pick up an item to be delivered and have the ability to deliver the item from one town or city to another overnight.

When a traveler uses a delivery service which picks up items, the starting location could be, for example, a residence of the traveler, a residence of a relative of the traveler or a lodging facility. Depending upon the starting location, the terminal location could likewise be a residence of the traveler, a residence of a relative of the traveler or a lodging facility. A lodging facility means an establishment such as a hotel, motel or resort which provides lodging in return for payment.

If a traveler with non-carry-on luggage requests a pick-up from a delivery service which picks up items, the delivery service collects the luggage from a starting location selected by the traveler. The delivery service loads the non-carry-on luggage onto a cargo carrier operated by the delivery service and transports the luggage to a terminal location selected by the traveler. The non-carry-on luggage can be collected from the starting location before the traveler's departure, at the time of the traveler's departure, or even after the traveler's departure.

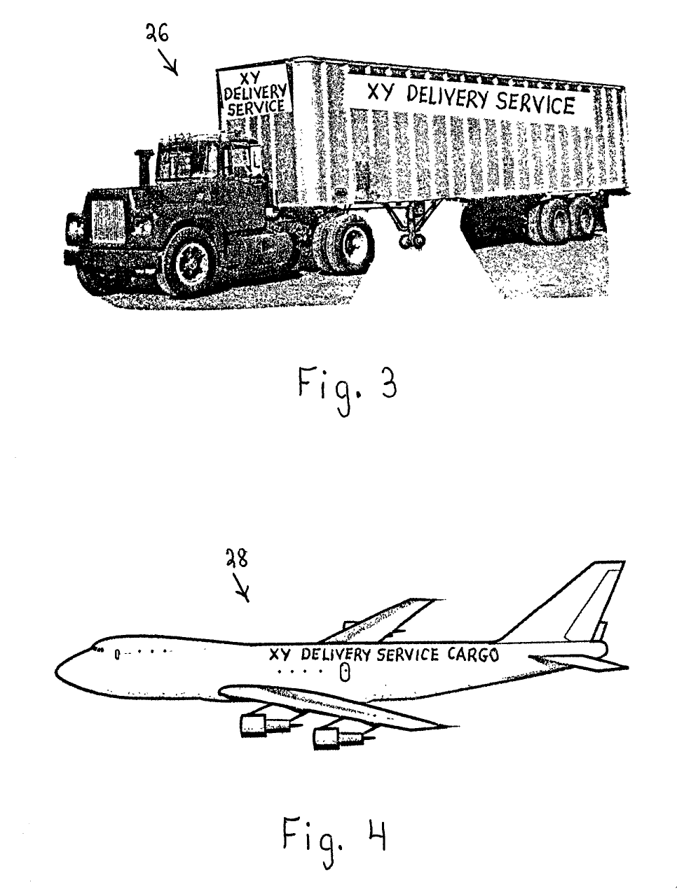

FIG. 3 shows a cargo carrier in the form of a truck 26 operated by XY Delivery Service while FIG. 4 shows a cargo carrier in the form of a cargo aircraft 28 which is also operated by XY Delivery Service.

A traveler may elect to take non-carry-on luggage to the departure airport. At the departure airport, the non-carry-on luggage is collected by baggage handlers who may be employed by the airport, by an airline company, by a delivery service or by some other entity. In any event, the non-carry-on luggage is loaded onto a cargo carrier at the departure airport and transported to a terminal location chosen by the traveler. The terminal location could be, for example, an airport to which the traveler is flying. The cargo carrier used to transport the non-carry-on luggage from the departure airport, i.e., the starting location, to the terminal location can be operated by a delivery service.

It is also possible for a traveler with non-carry-on luggage to take the luggage, or to have the luggage taken, to a drop-off location of a delivery service. The delivery service then collects the non-carry-on luggage from the drop-off location, loads the luggage onto a cargo carrier and transports the luggage to a terminal location of the traveler's choosing. The non-carry-on luggage may be dropped off before the traveler's departure or, if dropped off by someone other than the traveler, concurrently with or after the traveler's departure.

Other options for transporting non-carry-on luggage exist. For example, such luggage can be taken to a railroad terminal and loaded onto a cargo railcar for transport. It is also possible to send non-carry-on luggage from a starting location to a terminal location via a shipping company or a moving company.

By eliminating non-carry-on luggage from a commercial passenger aircraft, the safety of the aircraft can be enhanced in a relatively simple manner. Moreover, this allows costs to be reduced and may permit travelers to arrive at an airport closer to departure time than would otherwise be the case.

The use of a delivery service which is capable of delivering items overnight permits non-carry-on luggage to be sent the day before a traveler's departure and to be waiting for the traveler upon his or her arrival.

Various modifications are possible within the meaning and range of equivalence of the appended claims.

I claim:

1. A method of rendering air-travel service comprising the steps of:
conveying travelers by air to a predetermined destination, said travelers having articles of non-carry-on luggage, and the conveying step being performed with an aircraft devoid of non-carry-on luggage belonging to any traveler on said aircraft; and
transporting said articles of non-carry-on luggage to one or more locations where said articles of non-carry-on luggage are retrievable by said travelers following arrival of said travelers at said predetermined destination, the transporting step being performed with one or more conveyances other than said aircraft.

2. The method of claim 1, wherein one of said articles of non-carry-on luggage belongs to one of said travelers and said one article is transported to a predetermined location selected by said one traveler.

3. The method of claim 2, wherein said predetermined location is at an airfield.

4. The method of claim 2, wherein said predetermined location is at a lodging facility.

5. The method of claim 2, wherein said predetermined location is at a residence.

6. The method of claim 1, wherein said aircraft is operated by a first party and at least one of said conveyances is operated by a second party.

7. The method of claim 6, further comprising the steps of collecting one of said articles of non-carry-on luggage from a preselected location prior to the transporting step, and loading said one article of non-carry-on luggage on said one conveyance, the collecting step and the loading step each being performed by said second party.

8. The method of claim 7, wherein said preselected location is a at residence.

9. The method of claim 7, wherein said preselected location is at a lodging facility.

10. The method of claim 6, further comprising the steps of collecting one of said articles of non-carry-on luggage from one of said travelers at an airfield, and loading said article of non-carry-on luggage on said one conveyance, the loading step being performed by said second party.

11. The method of claim 1, wherein at least one of said conveyances is an aircraft.

12. The method of claim 1, wherein at least one of said conveyances is a truck.
